(19) United States
(12) Patent Application Publication
(10) Pub. No.: US 2015/0322196 A1
(43) Pub. Date: Nov. 12, 2015

(54) A POLYESTER POLYURETHANE MATERIAL WITH LONG TERM HYDROLYSIS RESISTANCE

(71) Applicant: BAYER MATERIALSCIENCE AG, Monheim Am Rhein (DE)

(72) Inventors: Hartmut NEFZGER, Pulheim (DE); Xiang LIU, Shanghai (CN); John ZHANG, Shanghai (KR); Sam Torres, Shanghai (CN)

(73) Assignee: BAYER MATERIALSCIENCE AG, Monheim Am Rhein (DE)

(21) Appl. No.: 14/762,242

(22) PCT Filed: Jan. 21, 2014
(86) PCT No.: PCT/EP2014/051079

§ 371 Date: Jul. 21, 2015

(30) Foreign Application Priority Data
Jan. 25, 2013 (CN) 201310041741.X 25

(51) Int. Cl. C08G 18/42; C09J 175/06; C09D 175/06

(52) U.S. Cl. CPC C08G 18/4238; C09D 175/06; C09J 175/06

(57) ABSTRACT

The present invention relates to a polyester polyurethane material with long term hydrolysis resistance which is prepared from perchlorates and a polyester polyol comprising structure unit I, II, and III. The polyester polyurethane material having a mole ratio of structure unit II to III of 1:1.5 to 1.5:1 has better long term hydrolysis resistance. In another aspect of the present invention, there is provided soles, carpets, rollers, sealing strips, coating, tires, wipers, steering wheels or gaskets prepared from the polyester polyurethane material, and a use of the polyester polyurethane material.

### FIELD

The present invention relates to a polyester polyurethane material with hydrolysis resistance, particular to a polyester polyurethane material prepared from a first polyester polyol and perchlorates. The present invention further relates to soles, carpets, rollers, sealing strips, coating, tires, wipers, steering wheels or gaskets prepared from the polyester polyurethane material and the use thereof.

### BACKGROUND

Polyester polyurethanes, because of favorable mechanical properties, chemical resistances, abrasion resistance, skin quality and machinability, are widely used in industries like footwear, automotive and furniture. However, the ester bonds within the polyester polyurethane material structure apt to hydrolyze, due to unavoidable exposure to moisture or direct contact with water during life cycle time, thus leading to cleavage of ester bonds and gradual or even complete physical properties loss of materials. Therefore, the industry has been looking for ways to improve the hydrolysis resistance of the polyester polyurethane materials.

So far, there are two ways to improve hydrolysis resistance of polyester polyurethane materials. One is to optimize the chemical structure of the polyester polyurethane so as to improve hydrophobicity or steric hindrance thereof, thus improving the hydrolysis resistance. WO 2006097507A1 discloses a polyester polyurethane material comprising 2-methyl-1,3-propylene glycol as structure unit which show satisfactory hydrolysis resistance. DE 3144968 discloses a polyurethane foam with improved hydrolysis and flexibility at low temperatures, which is prepared from polyester polyols prepared from adipic acid and a glycol mixture, wherein the glycol mixture is essentially consisted of 20-60 wt. % of 1,4-butanediol, 20-40 wt. % of 1,6-hexanediol, and 20-40 wt. % of neopentyl glycol and/or diethylene glycol.

Another approach is to add certain amounts of anti-hydrolysis additives to the formulation of these materials to improve hydrolysis resistance. For example, DE 10063497 discloses a way of improving the hydrolysis resistance of polyurethane materials by adding one or more monobasic or polybasic carboxylates with a first dissociation constant (pK) of 0.5 to 4 into the formulation of the polyurethane materials.

Although these methods are provided to improve hydrolysis resistance of polyester polyurethane materials, they don't fully meet the industry's requirements, especially for long-time hydrolysis resistance. Thus the industry is still need to develop polyester polyurethane materials with better hydrolysis resistance.

### SUMMARY

In one aspect, the present invention relates to a polyester polyurethane material, prepared by reacting the components comprising:
(a) one or more organic isocyanates;
(b) an isocyanate-reactive component having a hydroxyl value of 20-280 mgKOH/g and a functionality of 1.75-3.25 and comprising one or more first polyester polyols, wherein the first polyester polyol comprises the structure units:

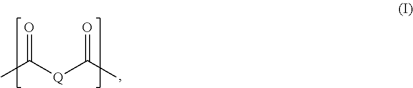

wherein Q represents two carbonyl linked directly, or alkylene groups optionally substituted by alkyl groups and/or aryl groups, or a phenylene groups optionally substituted by alkyl groups and/or aryl groups, or naphthalene groups optionally substituted by alkyl groups and/or aryl groups;

O—Y—O (II),
wherein Y represents a straight chain alkylene group comprising 2-10 carbon atoms;

O—Z—O (III),
wherein Z is selected from the group consisting of 2,2-dimethyl-1,3-propylidene, 3-methyl-1,5-pentamethylene, 3,3-dimethyl-1,5-pentamethylene, 3-ethyl-1,5-pentamethylene, 3,3-diethyl-1,5-pentamethylene, 3-methyl-3-ethyl-1,5-pentamethylene or the combination thereof;
(c) one or more perchlorates, wherein the cation of the perchlorate is selected from the group consisting of alkali, alkaline earth or ammonium.

In one embodiment of the present invention, the first polyester polyol is prepared by reacting the components comprising:
(b1) one or more dicarboxylic acid having a formula of

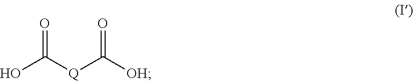

wherein Q represents two carbonyl linked directly, or alkylene groups optionally substituted by alkyl groups and/or aryl groups, or a phenylene groups optionally substituted by alkyl groups and/or aryl groups, or naphthalene groups optionally substituted by alkyl groups and/or aryl groups;
(b2) one or more diols having a formula of

HO—Y—OH (II′);
wherein Y represents a straight chain alkylene group comprising 2-10 carbon atoms;
(b3) one or more diols having a formula of

HO—Z—OH (III′)
wherein Z is selected from the group consisting of 2,2-dimethyl-1,3-propylidene, 3-methyl-1,5-pentamethylene, 3,3-dimethyl-1,5-pentamethylene, 3-ethyl-1,5-pentamethylene, 3,3-diethyl-1,5-pentamethylene, 3-methyl-3-ethyl-1,5-pentamethylene or the combination thereof.

In another embodiment of the present invention, the isocyanate-reactive component has a functionality of 1.8-2.3.

In yet another embodiment of the present invention, the isocyanate-reactive component has a hydroxyl value of 28-100 mg KOH/g.

In still another embodiment of the present invention, Q is selected from the group consisting of methylene, ethylene, 1,3-propylidene, 1,4-butylene, 1,5-pentamethylene, or 1,6-hexylene.

In still another embodiment of the present invention, Y is selected from the group consisting of ethylene, 1,3-propylidene, 1,4-butylene, 1,5-pentamethylene, or 1,6-hexylene.

In still another embodiment of the present invention, the components for preparing the first polyester polyol further comprises one or more small molecular polyol selected from the group consisting of glycerol, trimethylolpropane, or pentaerythritol.

In still another embodiment of the present invention, the perchlorate is the one or more selected from the group consisting of lithium perchlorate, sodium perchlorate, potassium perchlorate, rubidium perchlorate, cesium perchlorate, beryllium perchlorate, magnesium perchlorate, calcium perchlorate, strontium perchlorate, barium perchlorate, ammonium perchlorate or the combination thereof.

In still another embodiment of the present invention, the components for preparing polyester polyurethane material further comprises (d) one or more carboxylate which have a (first) dissociation constant of 0.5-4; preferably, the carboxylate is the one or more selected from the group consisting of dimethyl oxaloacetate, diethyl oxaloacetate, dibutyl oxaloacetate, γ-butyrolactone, γ-valerolactone, ε-caprolactone, α,γ-dimethyl butyrolactone, (β,γ-dimethyl butyrolactone, γ,γ-dimethyl butyrolactone, α-ethyl-γ-methyl butyrolactone and the combination thereof.

In still another embodiment of the present invention, the ratio of the structure unit (II) to (III) is 1:1.5 to 1.5:1 in the first polyester polyol, preferably 1:1.2 to 1.2:1.

In still another embodiment of the present invention, wherein the ratio of the component (b2) to (b3) is 1:1.5 to 1.5:1, preferably 1:2 to 1.2:1.

In still another embodiment of the present invention, the polyester polyurethane material is the one or more selected from the group consisting of polyurethane foam, microcellular elastomer and non-foaming polyurethane elastomer or the combination thereof.

In another aspect, the present invention relates to a polyester polyurethane article prepared from the above polyester polyurethane material, wherein the polyester polyurethane article is selected from the group consisting of soles, carpets, rollers, sealing strips, coating, tires, wipers, steering wheels or gaskets.

In yet another aspect, the present invention relates to a use of the above polyester polyurethane material in preparing soles, carpets, rollers, sealing strips, coating, tires, wipers, steering wheels or gaskets.

### DETAILED DESCRIPTION

### Polyester Polyurethane Materials

In one aspect, the present invention relates to a polyester polyurethane material, prepared by reacting the components comprising:
(a) one or more organic isocyanates;
(b) an isocyanate-reactive component having a hydroxyl value of 20-280 mgKOH/g and a functionality of 1.75-3.25 and comprising one or more first polyester polyols, wherein the first polyester polyol comprises the structure units:

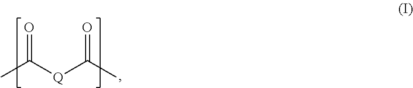

wherein Q represents two carbonyl linked directly, or alkylene groups optionally substituted by alkyl groups and/or aryl groups, or a phenylene groups optionally substituted by alkyl groups and/or aryl groups, or naphthalene groups optionally substituted by alkyl groups and/or aryl groups;

O—Y—O (II),
wherein Y represents a straight chain alkylene group comprising 2-10 carbon atoms;

O—Z—O (III),
wherein Z is selected from the group consisting of 2,2-dimethyl-1,3-propylidene, 3-methyl-1,5-pentamethylene, 3,3-dimethyl-1,5-pentamethylene, 3-ethyl-1,5-pentamethylene, 3,3-diethyl-1,5-pentamethylene, 3-methyl-3-ethyl-1,5-pentamethylene or the combination thereof;
(c) one or more perchlorates, wherein the cation of the perchlorate is selected from the group consisting of alkali, alkaline earth or ammonium.

Surprisingly, the applicant finds that the combination of the component (b) and (c) can improve the hydrolysis resistance of the obtained polyester polyurethane materials, especially the hydrolysis resistance is further improved when the mole ratio of the structure unit (II) to (III) in the component (b) is 1:1.5 to 1.5:1, preferably 1:1.2 to 1.2:1.

As used herein, the reaction comprises physical and chemical reactions, wherein the physical reaction includes mixing process.

As used herein, the polyester polyurethane materials refer to those having a density of 150-1200 kg/m³, and bearing carbamate bonds (—NHCOO—) in the backbone chain and ester bonds. The polyester polyurethane materials may be foams or non-foaming materials. In one preferred embodiment of the present invention, the polyester polyurethane material is the one or more selected from the group consisting of polyurethane foam, microcellular elastomer and non-foaming polyurethane elastomer or the combination thereof.

### Component (a)

The polyisocyanate of the component (a) may be illustrated by a general formula,

R(NCO)ₙ,
wherein n=2-4, preferably 2, and R represents an aliphatic hydrocarbon radical containing 2-18 carbon atoms, an aromatic hydrocarbon radical containing 6-15 carbon atoms, or an araliphatic hydrocarbon radical containing 8-15 carbon atoms.

Examples the polyisocyanate include but not limited to ethylene diisocyanate, 1,4-tetramethylene diisocyanate, 1,6-hexamethylene diisocyanate (HDI), 1,2-dodecane diisocyanate, cyclobutane-1,3-diisocyanate, cyclohexane-1,3- and 1,4-diisocyanates, 1-isocyanato-3,3,5-trimethyl-5-isocyanatomethyl-cyclohexane, 2,4- and 2,6-hexahydrotoluene diisocyanates, hexahydro-1,3- and 1,4-phenylene diisocyanate, perhydro-2,4- and 4,4-diphenylmethane diisocyanate, 1,3- and 1,4-phenylene diisocyanate, 1,4-durol-diisocyanate, 4,4′-stilbene diisocyanate, 3,3-dimethyl-4,4-biphenylene diisocyanate, toluene-2,4- and 2,6-diisocyanates (TDI), the mixture of toluene-2,4- and 2,6-diisocyanates, diphenylmethane-2,4′-, 2,2′- and 4,4′-diisocyanates (MDI), and naphthylene-1,5-diisocyanate (NDI).

The polyisocyanates also include the modifications of the above mentioned isocyanates containing carbodiimide, uretoneimine, allophanate or isocyanurate structures.

The polyisocyanates can also be prepolymers produced by the common process known in the art. The prepolymer preferably has a NCO content of 5-30 wt. %, more preferably 10-25 wt. %, based on 100% by weight of the polyisocyanate prepolymers.

### The Component (b)

The isocyanate-reactive component (b) of the present invention has a hydroxyl number of 20-280 mgKOH/g, preferably 28-100 mg KOH/g; and a functionality of 1.75-3.25, preferably 1.8-2.3 and comprises a first polyester polyol, wherein the first polyester polyol comprises one or more structure units comprising:

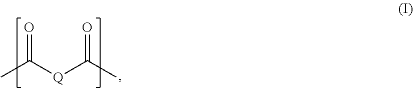

wherein Q represents two carbonyl linked directly, or alkylene groups optionally substituted by alkyl groups and/or aryl groups, or a phenylene groups optionally substituted by alkyl groups and/or aryl groups, or naphthalene groups optionally substituted by alkyl groups and/or aryl groups;

O—Y—O (II),
wherein Y represents a straight chain alkylene group comprising 2-10 carbon atoms;

O—Z—O (III),
wherein Z is selected from the group consisting of 2,2-dimethyl-1,3-propylidene, 3-methyl-1,5-pentamethylene, 3,3-dimethyl-1,5-pentamethylene, 3-ethyl-1,5-pentamethylene, 3,3-diethyl-1,5-pentamethylene, 3-methyl-3-ethyl-1,5-pentamethylene or the combination thereof.

It is well known to a person skilled in the art the method of determining hydroxyl number, for example the method disclosed in DIN 53240.

The first polyester polyol may prepared by the common process in the art, for example condensation of alcohols and carboxylates or transesterification reaction.

The structure unit I, II, and III in the first polyester polyol may connected differently according the preparation thereof, for example the structure unit I, II, and III are connected in a random or block way.

When Q represents two carbonyls linked directly, the structure unit (I) represents dicarbonyl. Q may also represent alkylene groups optionally substituted by alkyl groups and/or aryl groups, or a phenylene groups optionally substituted by alkyl groups and/or aryl groups, or naphthalene groups optionally substituted by alkyl groups and/or aryl groups

As used herein, the term “alkyl group” refers to straight or branched saturated monovalent hydrocarbon radicals containing 1-10 carbon atoms. The term “low alkyl group” refers to straight or branched hydrocarbon radicals containing 1-6 carbon atoms. Suitable examples of the alkyl groups include, but not limited to, methyl, ethyl, propyl, isopropyl, n-butyl, isobutyl, tert-butyl or pentyl, isopentyl, neopentyl, hexyl, heptyl and octyl.

As used herein, the term “aryl group” refers to phenyl or bicyclic fused system wherein one or two fused ring is selected from phenyl. Bicyclic fused system is fused by phenyl and 4 to 6 member aromatic ring or non-aromatic carbonic ring. Examples of aryl groups include, but not limited to, naphthyl, phenyl and tetrahydronaphthyl. The aryl groups of the present invention may be substituted by one, two, three, four, or five substituents.

As used herein, the term “alkylene group” refers to divalent straight saturated hydrocarbon radicals containing 1 to 10 carbon atoms, for example (CH₂)ₙ, or divalent branched saturated hydrocarbon radicals containing 2 to 10 atoms, for example —CHMe- or —CH₂CH(i-Pr)CH₂—.

As used herein, the term “phenylene group” refers to 1,2-phenylene (o-phenylene), 1,3-phenylene (m-phenylene), and 1,4-phenylene (p-phenylene).

As used herein, the term “naphthalene group” refers to the naphthyl groups having two position for bonding ester groups each.

In one preferred embodiment of the present invention, Q is selected from the group consisting of methylene, ethylene, 1,3-propylidene, 1,4-butylene, 1,5-pentamethylene, or 1,6-hexylene.

In the structure unit (II), Y represents straight alkylidene group containing 2 to 10 carbon atoms. In a preferred embodiment of the present invention, Y is selected from the group consisting of ethylene, 1,3-propylidene, 1,4-butylene, 1,5-pentamethylene, or 1,6-hexylene.

In the structure unit (III), Z is selected from the group consisting of 2,2-dimethyl-1,3-propylidene, 3-methyl-1,5-pentamethylene, 3,3-dimethyl-1,5-pentamethylene, 3-ethyl-1,5-pentamethylene, 3,3-diethyl-1,5-pentamethylene, 3-methyl-3-ethyl-1,5-pentamethylene or the combination thereof.

In a preferred embodiment of the present invention, the first polyester polyol is prepared by reacting the components comprising:

(b1) one or more dicarboxylic acid having a formula of

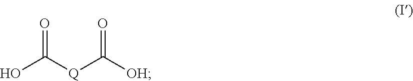

wherein Q represents two carbonyl linked directly, or alkylene groups optionally substituted by alkyl groups and/or aryl groups, or a phenylene groups optionally substituted by alkyl groups and/or aryl groups, or naphthalene groups optionally substituted by alkyl groups and/or aryl groups;
   (b2) one or more diols having a formula of

HO—Y—OH (II′);
wherein Y represents a straight chain alkylene group comprising 2-10 carbon atoms;
   (b3) one or more diols having a formula of

HO—Z—OH (III′)
wherein Q, Y, and Z are defined as above.

In one preferred embodiment of the present invention, the component (b1) may be selected from oxalic acid, malonic acid, succinic acid, glutaric acid, adipic acid and pimelic acid. More preferably, the component (b1) is selected from oxalic acid.

In one preferred embodiment of the present invention, the component (b2) is selected from ethylene glycol, 1,3-propanediol, 1,4-butanediol, 1,5-pentanediol, 1,6-hexanediol or the combination thereof; more preferably, the component (b2) is selected from 1,4-butanediol.

In one preferred embodiment of the present invention, the component (b3) is selected from neopentyl glycol 3-methyl-1,5-pentanediol, 3,3-dimethyl-1,5-pentanediol, 3-ethyl-1,5-pentanediol, 3,3-diethyl-1,5-pentanediol, 3-methyl-3-ethyl-1,5-pentanediol or the combination thereof; more preferably, the component (b3) is selected from neopentyl glycol.

In one preferred embodiment of the present invention, the reaction components for preparing the first polyester polyol may further comprise the component (b4), which is one or more small molecule polyhydric alcohols selected from glycerol, trimethylol propane and pentaerythritol. The polyester polyurethane materials prepared from such the first polyester polyol have better hydrolysis resistance.

It is well known to a person skilled in the art the preparation process of the first polyester polyol, for example the disclosure in Manuals of polyurethane raw materials and additives (chapter 3, Liu Yijun, published on Apr. 1, 2005), and Polyurethane elastomer (chapter 2, Liu Houjun, published on August, 2012), which are herein incorporated by reference in their entirety.

In one embodiment of the present invention, the components (b1), (b2), (b3) and optionally the component (b4) may take part in the reaction in the form of derivates thereof, for example acid chloride, ester, acid anhydride and the like.

In one preferred embodiment of the present invention, the ratio of the component (b2) to (b3) is 1:1.5 to 1.5:1, preferably 1:1.2 to 1.2:1, more preferably, 1:1. The polyester polyurethane materials prepared from such polyester polyols have favorable hydrolysis resistance, especially long-term hydrolysis resistance.

The isocyanate-reactive component of the present invention may further comprise polyether polyols, the second polyester polyols which are different with the first polyester polyols, or polycarbonate polyols.

Polyether polyols are optionally used to prepare the polyester polyurethane materials of the present invention. The polyether polyols may be produced by known process, e.g. in the reaction of alkene oxides with polyhydric alcohol starters in the presence catalysts such as alkali hydroxides, alkali alkoxides, antimony pentachloride, or boron fluoride etherate. Examples of the alkene oxides include tetrahydrofuran, ethylene oxide, 1,2-propylene oxide, 1,2- and 2,3-butylene oxide, and styrene oxide or the mixture thereof. The suitable starter molecules may be selected from polyhydric compounds, such as water, ethylene glycol, 1,2- and 1,3-propanediols, 1,4-butanediol, diethylene glycol, trimethylol-propane, or the mixture thereof. Suitable polyether polyols have a functionality of 2-8, preferably 2-6, more preferably 2-4, and a number average molecular weight of 500-8000, preferably 800-3500. And poly(propylene oxide-ethylene oxide)polyols are preferably used in the present invention.

The second polyester polyols are optionally used to prepare the polyester polyurethane materials of the present invention. The second polyester polyols are different from the first polyester polyols mentioned above. The polyester polyols may be produced from the reaction of organic dicarboxylic acids or dicarboxylic acid anhydrides with polyhydric alcohols. Suitable dicarboxylic acids are preferably aliphatic carboxylic acids containing 2 to 12 carbon atoms, for example, succinic acid, malonic acid, glutaric acid, adipic acid, suberic acid, azelaic acid, sebacic acid, decane-dicarboxylic acid, maleic acid, fumaric acid, phthalic acid, isophthalic acid, and terephthalic acid. Suitable anhydrides are, for example, phthalic anhydride, terachlorophthalic anhydride, and maleic anhydride. Representative polyhydric alcohols include ethanediol, diethylene glycol, 1,2- and 1,3-propanediols, dipropylene glycol, 1,3-methylpropanediol, 1,4-butanediol, 1,5-pentanediol, 1,6-hexanediol, neopentyl glycol, 1,10-decanediol, glycerol, trimethylol-propane, or mixtures of at least two of these diols. The second polyester polyols of lactones, for example, ε-caprolactone, can also be used.

The polycarbonate diols are optionally used to prepare the polyester polyurethane materials of the present invention. The polycarbonate polyols include those prepared by the reaction of diols, which include but not limited to 1,2-propanediol, 1,3-propanediol, 1,4-butanediol, 1,5-pentanediol, 1,6-hexanediol, diethylene glycol, trioxymethylene glycol and their mixtures, and phosgene or dialkyl or diaryl-carbonates which include but not limited to diphenyl carbonate, dimethyl carbonate, diethyl carbonate or the mixture thereof.

The polyester carbonate diols may be selected from, but not limited to aliphatic polycarbonate diols, which may be prepared from phosgene and dialkyl or diaryl-carbonate diols containing ester groups. The diols containing ester groups may be prepared by the ring-open transesterification reaction between ε-caprolactone and diols, or the reaction between dicarboxylate or derivates thereof and diols.

The polyether carbonate diols may be prepared from the reaction between alkene oxides, preferably propylene oxide, and carbon dioxide under catalyst.

Polymer polyols may be optionally used to prepare the polyester polyurethane materials of the present invention. The polymer polyols are preferably, but not limited to polyester polymer polyls, polyether polymer polyls and the mixture thereof.

The polyester polymer polyols refer to polymer modified polyester polyols, preferably graft polyester polyols and polyester polyol dispersions. The graft polyester polyol is preferably those based on styrene and/or acrylonitrile; the styrene and/or acrylonitrile can be obtained by in situ polymerization of styrene, acrylonitrile and the mixture thereof; In the mixture of styrene and acrylonitrile, the ratio of styrene to acrylonitrile is 90:10-10:90, preferably 70:30-30:70. The polymer polyester polyol comprises dispersion phase, conventionally in amount of 1 to 50 wt. %, preferably 1 to 45 wt. %, based on the total weight of the polyester polymer polyol component, such as inorganic fillers, polyureas, polyhydrazides and polyurethane containing tertiary amino groups and melamine in bonded form.

The polyether polymer polyols refer to polymer modified polyether polyols, preferably graft polyether polyols and polyether polyol dispersions. The graft polyether polyol is preferably those based on styrene and/or acrylonitrile; the styrene and/or acrylonitrile can be obtained by in situ polymerization of styrene, acrylonitrile and the mixture thereof; In the mixture of styrene and acrylonitrile, the ratio of styrene to acrylonitrile is 90:10-10:90, preferably 70:30-30:70. The polymer polyether polyol comprises dispersion phase, conventionally in amount of 1 to 50 wt. %, preferably 1 to 45 wt. %, based on the total weight of the polyether polymer polyol component, such as inorganic fillers, polyureas, polyhydrazides and polyurethane containing tertiary amino groups and melamine in bonded form.

### The Component (c)

The component (c) of the present invention is selected from one or more perchlorate salts, of which the counter cations are selected from the group consisting of alkali and alkaline earth elements and ammonium, and preferably lithium and sodium. The perchlorate salts can be used optionally in the form of anhydrous, hydrate or solution. The salts can be used individually or as admixture with each other. Typical examples of the salts include but not limited to beryllium perchlorate, lithium perchlorate, sodium perchlorate, magnesium perchlorate, calcium perchlorate, strontium perchlorate, barium perchlorate, and ammonium perchlorate. The component (c) is used in an amount of 0.05 to 5% by weight, preferably 0.1 to 2.5% by weight, based on 100% by weight of the polyurethane materials.

In the process of present invention, the perchlorate salts can be dispersed into the first polyester polyol of the component (b) or other components such as chain extenders, and then mixed with other component through mechanical stirring or other physical methods.

The component (c) is preferably in the form of solution by dissolving the perchlorate salts in solvent first, and then be dispersed into the first polyester polyols of the component (b) or other components to form a well dispersed dispersion. The solvents which is used to dissolve the component (c) may help the perchlorate well disperse into the first polyester polyols of the component (b) or other components such as chain extenders.

Examples of suitable solvent include water and compounds such as ether, ketone, ester, alcohol, amide, carbonate, sulfoxide, sulfone, substituted alkane, aromatic derivatives, heterocyclics and polymers, etc. Typical examples are tetrahydrofuran, acetone, acetonitrile, N,N-Dimethylacetamide, dimethyl sulfoxide, ethyl acetate, ethylene glycol, pyrrolidone, hexamethylphosphoryl triamide, N-methyl-2-pyrrolidone, 1,3-dimethyl-2-imidazolidinone, N,N-dimethylformamide, ionic liquids, polyether, polyacrylate, polysiloxane, and their substituted derivatives, etc. They can be used both individually and as admixture with each other. The solvent is used in an amount of 0.1 to 50% by weight, preferably 1 to 25% by weight, based on 100% by weight of obtained polyurethane materials.

### The Component (d)

One or more carboxylates having a (first) dissociation constant of 0.5 to 4, preferably 1-3, may be also used to prepared the polyester polyurethane materials of the present invention. The hydrolysis resistance of the polyester polyurethane materials may be further improved by adding the component (d).

The (first) dissociation constant of these carboxylate is determined in the aqueous solution of the carboxylate. The carboxylate is generally prepared from mono- or poly-carboxylic acids and mono- or polyhydric alcohols. Examples of the mono- or poly-carboxylic acids include alkylmonocarboxylic acids such as formic acid, arylmonocarboxylic acids such as α-naphthoic acid, alkylpolycarboxylic acids such as oxalic acid, malonic acid, maleic acid, fumaric acid and citric acid, arylpolycarboxylic acids such as isomers and alkyl-substituted derivatives of phthalic acid, 1,2,4-trimellitic acid, 1,2,4,5-pyromellitic acid, and naphthalene-dicarboxylic acid, and cyclic double esters of α-hydroxycarboxylic acids such as mandelic acid or lactic acid. Saturated C2-C4 alkylpolycarboxylic acids are preferably used; oxalic acid is particularly preferred. Examples of suitable mono- or polyhydric alcohols include aliphatic mono- and polyols such as methanol, ethanol, propanol, iso-propanol, ethylene glycol, 1,2- and 1,3-propanediol, isomers of butanol, 2-butene-1,4-diol, 2-butyne-1,4-diol, neopentyl glycol, glycerol, trimethylolpropane and pentaerythritol. Examples of suitable arylmono- or aryl poly-hydric alcohols include phenol and substituted derivatives thereof, naphthol and alkyl-substituted derivatives thereof, hydroquinone, resorcinol, trihydroxybenzenes, and all the polyether and polyether ester polyols mentioned in the component (b).

In one preferred embodiment of the present invention, the carboxylate is the one or more selected from the group consisting of dimethyl oxaloacetate, diethyl oxaloacetate, dibutyl oxaloacetate, γ-butyrolactone, γ-valerolactone, ε-caprolactone, α,γ-dimethyl butyrolactone, β,γ-dimethyl butyrolactone, γ,γ-dimethyl butyrolactone and α-ethyl-γ-methyl butyrolactone.

The blowing agents, chain extenders, catalyst, surfactants, pigments, fillers or other suitable additives may be added to prepared the polyester polyurethane materials of the present invention by a person skilled in the art according to practical needs.

Blowing agents used in the present invention may be any conventional physical foaming agent or chemical foaming agent. Suitable blowing agents include but not limited to water, halohydrocarbons, hydrocarbons and gases. Examples of halohydrocarbons are monochlorodifuloromethane, dichloromonofluoromethane, dichlorofluoromethane, and trichlorofluromethane or the mixture thereof. Examples of hydrocarbons include but not limit to butane, pentane, cyclopentane, hexane, cyclohexane, heptane and the mixture thereof. Blowing gases include, but not limited to, air, CO₂, and N₂. The blowing agent is most preferably water, and the amount of the blowing agent depends on the desired density of the prepared polyurethane.

The chain extenders typically are selected from active hydrogen atoms comprising compounds with molecular weights lower than 800, preferably from 18 to 400. The active hydrogen atoms comprising compounds are preferably, but are not limit to alkanediols, dialkylene glycols, and polyalkylene polyols and their mixtures. The examples are ethanediol, 1,4-butanediol, 1,6-hexanediol, 1,7-heptanediol, 1,8-octanediol, 1,9-nonanediol, 1,10-decanediol, diethylene glycol, dipropylene glycol, polyoxyalkylene glycols or the mixture thereof. Other suitable substances are branched chain and unsaturated alkanediols such as 1,2-propanediol, 2-methyl-1,3-propanediol, 2,2-dimethyl-1,3-propanediol, 2-butyl-2-ethyl-1,3-propanediol, 2-butene-1,4-diol and 2-butyne-1,4-diol, alkanolamines and N-alkyldialkanolamines such as ethanolamine, 2-aminopropanol and 3-amino-2,2-dimethylpropanol, N-methyl and N-ethyl-diethanolamines, as well (cyclo) aliphatic and aromatic amines, e.g. 1,2 ethylenediamine, 1,3-propylenediamine, 1,4-butylenediamine, 1,6-hexamethylenediamine, isophoronediamine, 1,4-cyclohexamethylenediamine, N,N′-diethyl-phenylenediamine, 2,4 and 2,6 diaminotolune or the mixture thereof. The amount of the extender is range from 1-50 wt. %, based on 100% by weight of the polyol and the chain extender in the reaction system.

The catalyst is preferably, but not limit to, amines and organic metal compounds and their mixtures. The amine catalyst is preferably, but not limit to, triethylamine, tributylamine, triethylene diamine, N-ethylmorpholine, N,N,N′,N′-tetramethyl-ethylenediamine, pentamethyl diethylene-triamine, N,N-methylaniline, N,N-dimethylaniline and mixtures thereof. The organic metal catalyst is preferably, but not limit to, stannous diacetate, stannous dioctoate, stannous diethylhexoate, and dibutyltin diacetate, dibutyltin dilaurate, ditutyltin maleate, and dioctyltin diacetate and mixtures thereof. The amount of the catalyst is range 0.001-10 wt. %, based on 100% by weight of the polyol component of the reaction system.

Suitable surfactants are preferably but not limited to polyoxyalkylene derivatives of siloxane, in an amount of 0.01 to 8 wt. %, based on 100% by weight of the polyol and the chain extender.

The pigments and/or fillers of the present invention are preferably, but not limit to calcium carbonate, graphite, carbon black, titanium dioxide, ferric oxide, aluminum trihydroxide, wollastonite, glass fiber, polyester fiber, and polymer fiber.

### Preparation of the Polyester Polyurethane Materials

The polyester polyurethane materials of the present invention are prepared as following: mixing the components mentioned above in the presence of optional catalysts and optionally blowing agents and surfactants, under 20 to 80° C., preferably 30 to 60° C.; injecting the above mixture into a mold in an open or close way, and demoulding to obtained a polyurethane product after 1-15 minutes. For detailed procedures, please refer to handbook Kunststoff Handbuch, Volume VII, Polyurethanes (1994 by Dr. G. Oertel, Carl-Hanser-Verlag, Munich). The molds described herein are those commonly used in the existing technology to prepare polyurethanes, in which the reaction system can react to provide the polyurethanes of the present invention.

The NCO index of the reaction may be optimized by the method well-known in prior art.

The NCO Index of the reaction is preferred but not limited to be 50-160, particularly preferred 80-120, and it is defined as:

$$X = \frac{[ \begin{matrix}moles of isocyanate group \\ ( NCO group ) in the recation components\end{matrix} ]}{[ \begin{matrix}moles of isocyanate reactive group comprised \\ in the reaction components\end{matrix} ]} \times 100$$

### Polyester Polyurethane Article

The present invention relates to a polyester polyurethane article prepared from the polyester polyurethane materials according to the process well known to a person skilled in the art, and the polyester polyurethane article is selected from the group consisting of soles, carpets, rollers, sealing strips, coating, tires, wipers, steering wheels or gaskets.

Particular, the present invention relates to a shoe sole prepared from the above polyester polyurethane materials.

In preferred embodiments of the present invention, the polyurethane shoe sole refers to outsole, which has a density of 400-1200 kg/m³ in general. In the present invention, the density of the polyurethane foam means the average density over the entire foam, i.e. in the case of integral foams this information relates to the average density of the entire foam inclusive of core and outer layer. The integral foam is preferably prepared in the mold mentioned above, therefore the density of the obtained foam is also referred as the density of the article.

In another preferred embodiment of the present invention, the polyurethane shoe sole is midsole, which has a density of 250-600 kg/m3 in general.

In another preferred embodiment of the present invention, the polyurethane shoe sole is molded sole, which should be considered as those act as outsole and midsole in one shoe sole. The molded sole has a density of 300-650 kg/m3 in general.

The shoe sole of the present invention has favorable hydrolysis resistance, particular long term hydrolysis resistance, and good physical properties and processability.

In yet another aspect, the present invention relates to a use of the polyester polyurethane material mentioned above in preparing soles, carpets, rollers, sealing strips, coating, tires, wipers, steering wheels or gaskets.

### EXAMPLES

The following examples are illustrative only, and are not intended to limit the scope of the present invention. The following examples generally were carried out under conventional conditions or those recommended by the manufacturers and all the percentages are by weight percentage unless otherwise specified.

The commercial products used in the examples are listed as following:
Dabco EG: Amine catalyst supplied by Air Products;
Dabco DC 193: Silicone surfactant supplied by Air Products;
Isocyanate 1 (Desmodur 0926): a polyester urethane-modified polyisocyanate having an isocyanate content of 19.0 wt. % NCO from Bayer MaterialScience;
Isocyanate 2: the isocyanate I comprising 0.5 wt. % of diethyl oxalate;

### Example 1-3

### Preparation of the First Polyester Polyol I, II and III

To a 10 liter flask equipped with a mechanical stirrer, 50 cm packed fractionating column, thermometer, nitrogen inlet, distillation head and a membrane vacuum pump, raw materials are added in the amount according to table 1. This mixture was slowly heated to 200° C. at atmospheric pressure within 60 minutes. After 5 hours no more water was generated, tin-dichloride dihydrate was added in the amount according to table 1, the pressure slowly reduced to 20 mbar eventually. After a total reaction time of 40 hours, in order to replace the distilled off 1,4-butanediol and to adjust the hydroxyl number to the desired value, 88 g 1,4-butanediol were added and the reaction was continued for another 6 hours under 200° C. at atmospheric pressure.

The property of the obtained first polyester polyol was shown in table 1, wherein, the dynamic viscosity is determined with Anton Paar Rheometer MCR 51 according to DIN 53019, the hydroxyl number is determined according to DIN 53240, and the acid number is determined according to DIN 53402.

TABLE 1
The raw materials and the properties of
the prepared first polyester polyol

| | | Example 1 | Example 2 | Example 3 |
|---|---|---|---|---|
| | | (The first | (The first | (The first |
| | | polyester | polyester | polyester |
| | | poly III) | poly I) | poly II) |
| Adipic Acid(g) | | 5481 | 5342 | 5229 |
| 1,4-butanediol (g) | | 1874 | 2428 | 1191 |
| Neopentyl glycol (g) | | 2168 | 1403 | 2753 |
| TMP (g) | | 29 | 27 | 27 |
| Tin dichloride dihydrate (mg) | | 191 | 184 | 184 |
| Mole ratio of butanediol/neopentyl | | 1:1 | 2:1 | 1:2 |
| glycol | | | | |
| Hydroxyl value (mg KOH/g) | | 59.6 | 56.8 | 57.6 |
| Acid value (mg KOH/g) | | 0.82 | 0.12 | 0.9 |
| Viscosity | (mPas, 25° C.) | 13900 | 12900 | 16900 |
| | (mPas, 50° C.) | 2670 | 2560 | 2950 |
| | (mPas, 75° C.) | 850 | 980 | 860 |

| | | | |
|---|---|---|---|
| Functionality (calculated) | 2.05 | 2.05 | 2.05 |

### Example 3 and 4

The polyols and additives in an amount according to table 3 were homogenized by a PENDRAULIK mixer at a speed of 1400 rpm. The weight shown in table 3 is weight by part. Then the mixture of the polyols and additives (45° C.) was mixed and reacted with the isocyanate (40° C.) in an amount according to table 3 through GUSBI low pressure pouring machine (GUSBI Officina Meccanica S.P.A., ITALY), and injected into a sheet shaped mould (200 mm*200 mm*10 mm, 50° C.), closed the mould and reacted for 5 minutes, demoled to obtain the polyurethane. The obtained sheet shaped polyurethane was determined after standing at room temperature for at least 48 hours. Before the hydrolysis resistance test, the initial physical properties of the sample were determined according to the standard below:
Density: DIN EN ISO 845,
Hardness: DIN 53505,
Tensile strength: ASTM D412,

Then, the samples were subjected to hydrolysis at 70° C. and 95% relative humidity. The samples were taken out at predetermined intervals and then conditioned at 23 □, 50% relative humidity for 24 hours. After conditioning, the samples were cut into dumbbell shape for tensile strength determined according to the standard ASTM D412. The results are given in Table 3.

TABLE 3
the polyester polyurethane material
and the hydrolysis resistance thereof

| | Example 3 | Example 4 |
|---|---|---|
| The first polyester poly III | 100 | 100 |
| Ethylene glycol | 7.50 | 7.50 |
| Dabco EG | 1.50 | 1.50 |
| Dabco DC 193 | 0.20 | 0.20 |
| Sodium perchlorate | 0.3 | — |
| Water | 0.50 | 0.50 |
| Isocyanate 1 | Isocyanate | Isocyanate |
| | index: 100 | index: 100 |
| Density (kg/m³) | 500 | 500 |
| Hardness (Shore A) | 54 | 54 |
| Tensile strength (MPa) | 4.7 | 4.6 |
| After hydrolysis | | |
| Retention rate of tensile strength (%), | 84 | 90 |
| 1 week | | |
| Retention rate of tensile strength (%), | 83 | 83 |
| 2 weeks | | |
| Retention rate of tensile strength (%), | 80 | 55 |
| 3 weeks | | |
| Retention rate of tensile strength (%), | 61 | 27 |
| 4 weeks | | |

As shown in table 3, compared to the polyester polyurethane materials prepared from the components comprising the polyester polyols (example 4), the polyester polyurethane materials prepared from the components comprising the polyester polyols and sodium perchlorate (example 3) have significantly improved tensile retention after 2 weeks.

### Example 5-7

Examples 5-7 are prepared with the same method as examples 3-4. The components and the amount thereof are listed in table 4.

TABLE 3
the polyester polyurethane material
and the hydrolysis resistance thereof

| | Example 5 | Example 6 | Example 7 |
|---|---|---|---|
| The first polyester poly I | 100 | — | — |
| The first polyester poly II | — | 100 | — |
| The first polyester poly III | — | — | 100 |
| Ethylene glycol | 7.5 | 7.5 | 7.5 |
| Dabco EG | 1.5 | 1.5 | 1.5 |
| Dabco DC 193 | 0.2 | 0.2 | 0.2 |
| Sodium perchlorate | 0.3 | 0.3 | 0.3 |
| Water | 0.5 | 0.5 | 0.5 |
| Isocyanate 2 | Isocyanate | Isocyanate | Isocyanate |
| | index: 100 | index: 100 | index: 100 |
| Density (kg/m³) | 500 | 500 | 500 |
| Hardness (Shore A) | 54 | 55 | 55 |
| Tensile strength (MPa) | 4.8 | 3.5 | 5.1 |
| Hydrolysis resistance | | | |
| Retention rate of tensile strength (%), | 105 | 108 | 110 |
| 1 week | | | |
| Retention rate of tensile strength (%), | 99 | 101 | 108 |
| 2 weeks | | | |
| Retention rate of tensile strength (%), | 85 | 73 | 104 |
| 3 weeks | | | |
| Retention rate of tensile strength (%), | 76 | 53 | 93 |
| 4 weeks | | | |

According to the result shown in table 4, compared to the polyester polyurethane materials based on the first polyester polyol I and polyol II, the polyester polyurethane material based on the first polyester polyol III has a tensile strength of more than 90% even after 28 days of hydrolysis, thus it has better long term hydrolysis resistance.

1.-17. (canceled)

18. A polyester polyurethane material, prepared by reacting components comprising:
(a) one or more organic isocyanate;
(b) an isocyanate-reactive component having a hydroxyl value of 20-280 mgKOH/g and a functionality of 1.75-3.25 and comprising one or more first polyester polyol, wherein the first polyester polyol comprises the structure units: 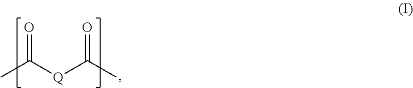
wherein Q represents two carbonyl linked directly, or an alkylene group optionally substituted by alkyl groups and/or aryl groups, or a phenylene group optionally substituted by alkyl groups and/or aryl groups, or a naphthalene group optionally substituted by alkyl groups and/or aryl groups;
O—Y—O (II),
wherein Y represents a straight chain alkylene group comprising 2-10 carbon atoms;
O—Z—O (III),
wherein Z is selected from the group consisting of 2,2-dimethyl-1,3-propylidene, 3-methyl-1,5-pentamethylene, 3,3-dimethyl-1,5-pentamethylene, 3-ethyl-1,5-pentamethylene, 3,3-diethyl-1,5-pentamethylene, 3-methyl-3-ethyl-1,5-pentamethylene, and combinations thereof; and
(c) one or more perchlorate, wherein the cation of the perchlorate is selected from the group consisting of alkali, alkaline earth, and ammonium.

19. The polyester polyurethane material according to claim 18, wherein the first polyester polyol is prepared by reacting components comprising:
(b1) one or more dicarboxylic acid having a formula of 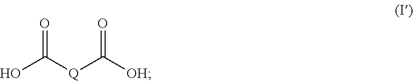
wherein Q represents two carbonyl linked directly, or an alkylene group optionally substituted by alkyl groups and/or aryl groups, or a phenylene group optionally substituted by alkyl groups and/or aryl groups, or a naphthalene group optionally substituted by alkyl groups and/or aryl groups;
(b2) one or more diol having a formula of
HO—Y—OH (II′);
wherein Y represents a straight chain alkylene group comprising 2-10 carbon atoms;
(b3) one or more diol having a formula of
HO—Z—OH (III′)
wherein Z is selected from the group consisting of 2,2-dimethyl-1,3-propylidene, 3-methyl-1,5-pentamethylene, 3,3-dimethyl-1,5-pentamethylene, 3-ethyl-1,5-pentamethylene, 3,3-diethyl-1,5-pentamethylene, 3-methyl-3-ethyl-1,5-pentamethylene, and combinations thereof.

20. The polyester polyurethane material according to claim 18, wherein the isocyanate-reactive component has a functionality of 1.8-2.3.

21. The polyester polyurethane material according to claim 18, wherein the isocyanate-reactive component has a hydroxyl value of 28-100 mg KOH/g.

22. The polyester polyurethane material according to claim 18, wherein Q is selected from the group consisting of methylene, ethylene, 1,3-propylidene, 1,4-butylene, 1,5-pentamethylene, and 1,6-hexylene.

23. The polyester polyurethane material according to claim 18, wherein Y is selected from the group consisting of ethylene, 1,3-propylidene, 1,4-butylene, 1,5-pentamethylene, and 1,6-hexylene.

24. The polyester polyurethane material according to claim 19, wherein the components for preparing the first polyester polyol further comprises one or more small molecular polyol selected from the group consisting of glycerol, trimethylolpropane, and pentaerythritol.

25. The polyester polyurethane material according to claim 18, wherein the one or more perchlorate is selected from the group consisting of lithium perchlorate, sodium perchlorate, potassium perchlorate, cesium perchlorate, beryllium perchlorate, magnesium perchlorate, calcium perchlorate, strontium perchlorate, barium perchlorate, ammonium perchlorate, and combinations thereof.

26. The polyester polyurethane material according to claim 18, wherein the components for preparing polyester polyurethane material further comprise (d) one or more carboxylate which has a first dissociation constant of from 0.5 to 4.

27. The polyester polyurethane material according to claim 26, wherein the one or more carboxylate is selected from the group consisting of dimethyl oxaloacetate, diethyl oxaloacetate, dibutyl oxaloacetate, γ-butyrolactone, γ-valerolactone, ε-caprolactone, α,γ-dimethyl butyrolactone, β,γ-dimethyl butyrolactone, γ,γ-dimethyl butyrolactone, and α-ethyl-γ-methyl butyrolactone.

28. The polyester polyurethane material according to claim 18, wherein the ratio of the structure unit (II) to (III) is 1:1.5 to 1.5:1 in the first polyester polyol.

29. The polyester polyurethane material according to claim 28, wherein the ratio of the structure unit (II) to (III) is 1:1.2 to 1.2:1 in the first polyester polyol.

30. The polyester polyurethane material according to claim 19, wherein the ratio of the component (b2) to (b3) is 1:1.5 to 1.5:1.

31. The polyester polyurethane material according to claim 30, wherein the ratio of the component (b2) to (b3) is 1:2 to 1.2:1.

32. The polyester polyurethane material according to claim 18, wherein the polyester polyurethane material is a polyurethane foam, a microcellular elastomer, a non-foaming polyurethane elastomer or a combination thereof.

33. A polyester polyurethane article prepared from the polyester polyurethane material according to claim 18, wherein the polyester polyurethane article is a sole, a carpet, a roller, a sealing strip, a coating, a tire, a wiper, a steering wheel or a gasket.

34. A method for preparing a sole, a carpet, a roller, a sealing strip, a coating, a tire, a wiper, a steering wheel or a gasket comprising utilizing the polyester polyurethane material of claim 18.
